(19) United States
(12) Patent Application Publication
(10) Pub. No.: US 2024/0368957 A1
(43) Pub. Date: Nov. 7, 2024

(54) SEAL ARRANGEMENT, METHOD, AND SYSTEM

(71) Applicant: Baker Hughes Oilfield Operations LLC, Houston, TX (US)

(72) Inventors: Jamie Imhoff, Houston, TX (US); Farhat A. Shaikh, Houston, TX (US)

(21) Appl. No.: 18/312,226

(22) Filed: May 4, 2023

(51) Int. Cl. E21B 33/10; F16J 15/16

(52) U.S. Cl. CPC E21B 33/10; F16J 15/32; E21B 2200/01

(57) ABSTRACT

A seal arrangement including a T-seal, a backup adjacent the T-seal, and a bullet seal adjacent the backup and responsive to the backup to splay a wing of the bullet seal. A method for sealing a system, including running a seal arrangement into a tubular structure, sealing the arrangement to the structure, and radially retaining the T-Seal with the backup. A borehole system, including a borehole in a subsurface formation, a string in the borehole, and a seal arrangement disposed within or as a part of the string.

### BACKGROUND

In the resource recovery and fluid sequestration industries, sealing of tubular structures is often important to operations. Various arrangements are employed currently and work acceptably for some applications but other applications suffer, such as those in which multiple deployments and retrievals are common and pressure reversals are common. In these situations, the art would well receive alternative arrangements to create robust sealing.

### SUMMARY

An embodiment of a seal arrangement including a T-seal, a backup adjacent the T-seal, and a bullet seal adjacent the backup and responsive to the backup to splay a wing of the bullet seal.

An embodiment of a method for sealing a system, including running a seal arrangement into a tubular structure, sealing the arrangement to the structure, and radially retaining the T-Seal with the backup.

An embodiment of a borehole system, including a borehole in a subsurface formation, a string in the borehole, and a seal arrangement disposed within or as a part of the string.

### BRIEF DESCRIPTION OF THE DRAWINGS

The following descriptions should not be considered limiting in any way. With reference to the accompanying drawings, like elements are numbered alike:

FIG. 1 is a schematic section al view of a seal arrangement as disclosed herein;

FIG. 2 is a schematic view of a borehole system including the seal arrangement as disclosed herein.

### DETAILED DESCRIPTION

A detailed description of one or more embodiments of the disclosed apparatus and method are presented herein by way of exemplification and not limitation with reference to the Figures.

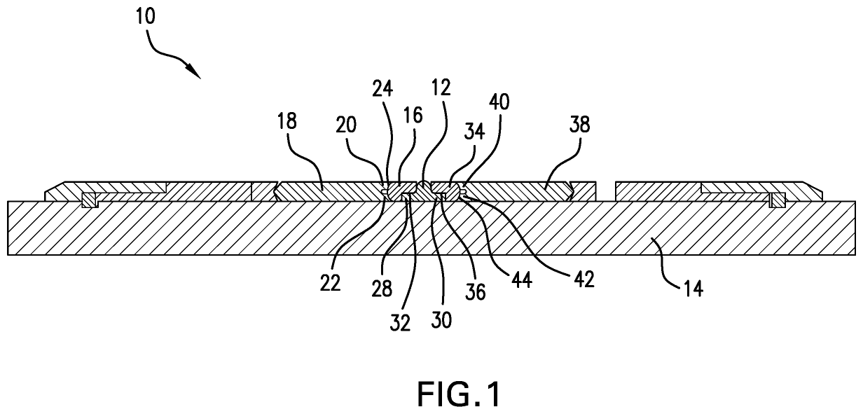

Referring to FIG. 1, a seal arrangement 10 is illustrated. Arrangement 10 includes a T-seal 12 that may be mounted upon a mandrel 14. The T-seal 12 is disposed adjacent a backup 16 and the backup 16 is disposed adjacent a bullet seal 18. It will be understood that the bullet seal 18 includes wings 20 and 22. Wings 20 and 22 are responsive to contact with the backup 16, when experiencing pressure applied thereto to splay providing a better seal against a radially outwardly disposed tubular structure (not shown) such as a casing or another tubular member against which a seal is desired. Assisting the splaying action is a convexity 24 of the backup 16.

The backup 16 is geometrically constructed to radially retain the T-seal 12. Specifically, it will be appreciated that T-seal 12 includes flanges 28 and 30. Backup 16 is configured with a notch 32 that nests with the flange 28, hence capturing the T-seal 12 to the mandrel 14. In embodiments where a second backup 34 is disposed adjacent the other side of the T-seal 12, that backup will also possess a notch 36 that captures the flange 30. In such embodiments, the T-seal 12 is captured from both longitudinal ends thereof and is well retained against pressure mediated or movement mediated ejection from its gland. Such embodiments also may contain a second bullet seal 38 having its own wings 40 and 42. Backup 34 will then also possess a convexity 44 that functions as does the convexity 24 discussed above. This results in a much more robust arrangement 10 than existing seal arrangements. For example, existing seals when unloaded from a tubular structure and especially when under differential pressure tend to experience damage at a rate that requires much earlier maintenance than will be the case with the arrangement disclosed herein. Further, arrangement 10 is much more resistant to traveling over long distances of casing, running over edges, etc.

In embodiments, the backup 16 and or 34 may comprise material properties including but not limited to heat tolerance (i.e. temperature tolerance for at least 350 F), hardness ranges of from 80-95 shore D, etc. In embodiments, the material may be a thermoplastic. In one particular embodiment the material is a Polyether Ether Ketone (PEEK). The backups could also be metal material, however. Soft metals (copper, lead, brass, etc.) will assist with sealing as well.

Arrangement 10 allows a single seal stack to be incorporated in many varied completions equipment and applications including, but not limited to, sliding sleeves, packer locator seal assemblies, anchor seal assemblies, PBRs, etc.

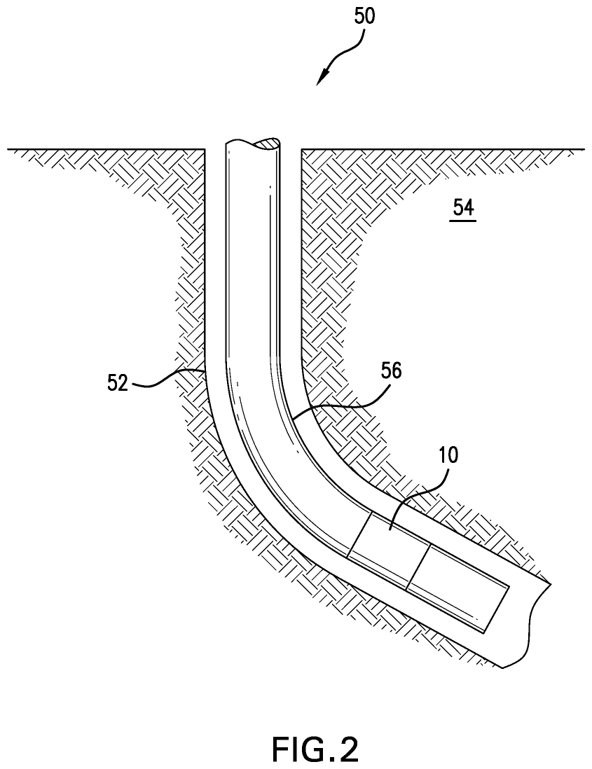

Referring to FIG. 2, a borehole system 50 is illustrated. The system 50 comprises a borehole 52 in a subsurface formation 54. A string 56 is disposed within the borehole 52. A seal arrangement 10 as disclosed herein is disposed within or as a part of the string 56.

Set forth below are some embodiments of the foregoing disclosure:

Embodiment 1: A seal arrangement including a T-seal, a backup adjacent the T-seal, and a bullet seal adjacent the backup and responsive to the backup to splay a wing of the bullet seal.

Embodiment 2: The arrangement as in any prior embodiment, wherein the backup is geometrically structured to overlay a portion of the T-seal.

Embodiment 3: The arrangement as in any prior embodiment, wherein the backup captures the T-seal against a radially inwardly positioned structure to the T-seal.

Embodiment 4: The arrangement as in any prior embodiment, wherein the backup includes a convexity interactive with the wing of the bullet seal.

Embodiment 5: The arrangement as in any prior embodiment, wherein the backup comprises a material having a hardness range of about 80-about 95 Shore D.

Embodiment 6: The arrangement as in any prior embodiment, wherein the backup comprises a thermoplastic.

Embodiment 7: The arrangement as in any prior embodiment, wherein the backup comprises a metal.

Embodiment 8: The arrangement as in any prior embodiment, wherein the backup comprises Polyether Ether Ketone (PEEK) material.

Embodiment 9: The arrangement as in any prior embodiment, further including a second backup adjacent the T-seal and second bullet seal adjacent the second backup and responsive to the backup to splay a wing of the second bullet seal.

Embodiment 10: The arrangement as in any prior embodiment, wherein the bullet seal includes two wings.

Embodiment 11: The arrangement as in any prior embodiment, wherein the wings are radially stacked.

Embodiment 12: A method for sealing a system, including running a seal arrangement as in any prior embodiment into a tubular structure, sealing the arrangement to the structure, and radially retaining the T-Seal with the backup.

Embodiment 13: The method as in any prior embodiment, further comprising splaying the wing with the backup.

Embodiment 14: The method as in any prior embodiment, further comprising capturing the T-seal against a radially inwardly disposed structure with the backup.

Embodiment 15: The method as in any prior embodiment, further comprising moving the arrangement after sealing and repositioning.

Embodiment 16: The method as in any prior embodiment, further comprising resealing the arrangement to the structure.

Embodiment 17: The method as in any prior embodiment, further including a second backup and second bullet seal, the second backup capturing the T-seal against a radially inwardly disposed structure with the second backup.

Embodiment 18: A borehole system, including a borehole in a subsurface formation, a string in the borehole, and a seal arrangement as in any prior embodiment disposed within or as a part of the string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

1. A seal arrangement comprising:
a T-seal;
a backup adjacent the T-seal; and
a seal adjacent the backup and responsive to the backup to splay a wing of the seal.

2. The arrangement as claimed in claim 1, wherein the backup is geometrically structured to overlay a portion of the T-seal.

3. The arrangement as claimed in claim 2, wherein the backup captures the T-seal against a radially inwardly positioned structure to the T-seal.

4. The arrangement as claimed in claim 1, wherein the backup includes a convexity interactive with the wing of the seal.

5. The arrangement as claimed in claim 1, wherein the backup comprises a material having a hardness range of about 80-about 95 Shore D.

6. The arrangement as claimed in claim 1, wherein the backup comprises a thermoplastic.

7. The arrangement as claimed in claim 1, wherein the backup comprises a metal.

8. The arrangement as claimed in claim 1, wherein the backup comprises Polyether Ether Ketone (PEEK) material.

9. The arrangement as claimed in claim 1, further including a second backup adjacent the T-seal and second seal adjacent the second backup and responsive to the backup to splay a wing of the second seal.

10. The arrangement as claimed in claim 1, wherein the seal includes two wings.

11. The arrangement as claimed in claim 10, wherein the wings are radially stacked.

12. A method for sealing a system, comprising:
running a seal arrangement as claimed in claim 1 into a tubular structure;
sealing the arrangement to the structure; and
radially retaining the T-Seal with the backup.

13. The method as claimed in claim 12, further comprising splaying the wing with the backup.

14. The method as claimed in claim 12, further comprising capturing the T-seal against a radially inwardly disposed structure with the backup.

15. The method as claimed in claim 12, further comprising moving the arrangement after sealing and repositioning.

16. The method as claimed in claim 15, further comprising resealing the arrangement to the structure.

17. The method as claimed in claim 12, further including a second backup and second seal, the second backup capturing the T-seal against a radially inwardly disposed structure with the second backup.

18. A borehole system, comprising:
a borehole in a subsurface formation;
a string in the borehole; and
a seal arrangement as claimed in claim 1 disposed within or as a part of the string.

19. The arrangement as claimed in claim 1, wherein the seal is a bullet seal.
